(19) United States
(12) Patent Application Publication
(10) Pub. No.: US 2007/0043819 A1
(43) Pub. Date: Feb. 22, 2007

(54) Electronic mail system, mail server and mail terminal

(75) Inventors: Makoto Katagishi, Chigasaki (JP); Kenji Sano, Yokohama (JP); Osamu Hasegawa, Mito (JP)

Correspondence Address: MCDERMOTT WILL & EMERY LLP, 600 13TH STREET, N.W., WASHINGTON, DC, 20005-3096, US

(73) Assignee: Hitachi, Ltd., Tokyo (JP)

(21) Appl. No.: 11/589,101

(22) Filed: Oct. 30, 2006

Related U.S. Application Data
(63) Continuation of application No. 10/282,257, filed on Oct. 29, 2002.

(30) Foreign Application Priority Data
Oct. 31, 2001 (JP) 2001-334874

(51) Int. Cl. G06F 15/16

(52) U.S. Cl. 709/206

(57) ABSTRACT

A mail server and mail terminals are connected through a radio communication network. The mail server makes viral infection decision of if e-mails are infected with computer virus without burdening the mail terminals having poor processing power. The mail terminals are constructed to serve as small-sized mail terminals. When an e-mail arrives at the mail server through the Internet, the mail server decides if the e-mail is infected with virus. The result of the viral infection decision is added as the whole or a part of inspection information within the header of the e-mail. The corresponding mail terminal can detect presence or absence of viral infection on the basis of the inspection information. When the e-mail is infected with virus, the mail terminal can inform a user of the contaminated e-mail by making tone of a buzzer or vibrator different from a normal e-mail.

### BACKGROUND OF THE INVENTION

The present invention relates to an electronic mail system, mail server and mail terminal.

An electronic mail (e-mail) system is comprised of mainly a mail server and mail clients (electronic mail software). The mail server is usually installed at each domain, for example, established on a network by an Internet Service Provider or mobile-phone carrier. A user transmits and receives electronic mails to and from a mail server by use of a mail terminal in which a mail client operates, such as a personal computer, a cell phone or a personal digital assistance (PDA).

When a certain user (addresser) transmits an electronic mail to another user (addressee), the e-mail sent from the addresser is transmitted to the mail server of the addressed domain by use of a mail transfer protocol such as SMTP (Simple Mail Transfer Protocol). The mail server has private-use directories (mail boxes) provided for respective users. The e-mail arrived at the mail server is sorted and stored at each addressed mailbox. When the user receives the e-mail, the mail client takes out the e-mail from the mailbox and brings it within the mail terminal by use of a mail receiving protocol such as POP3 (Post Office Protocol Version 3). The e-mail format is expanded by, for example, MIME (Multipurpose Internet Mail Extensions), so that the binary files such as graphics files, music files or program files can be attached to the text.

As the electronic mail system has been widely used, the computer system has been increasingly damaged by computer virus (hereinafter, simply called “virus”) through e-mail. If the user, when reading, opens a binary file containing virus that was attached to an e-mail as described above, the virus intrudes into the system of the terminal, damaging data.

Therefore, so-called anti-virus software that finds and exterminates the virus is previously installed on the mail terminal as described in, for example, JP-A-2001-134433, or a technique that uses this anti-virus software to inspect whether a received e-mail is infected with virus. This anti-virus software finds virus by, for example, comparing the information pattern of the attached file with a known virus pattern, and raises an alert to the user.

The conventional art that examines the presence or absence of virus within the mail terminal as described in the above publication has such drawbacks as given below. First, the user needs to always acquire the latest virus pattern, and thus takes a lot of trouble. The virus changes from day to day, and a few subspecies of the virus that caused a state of confusion in the world sometimes occur. Therefore, the virus pattern within the mail terminal must be updated at all times, otherwise the users cannot cope with this unknown new virus. The updating of the virus pattern, however, obliges the users to take a lot of labors.

Inspecting of whether there is a viral infection within the mail terminal consumes a certain amount of the computer resources (CPU execution time and memory) of the mail terminal depending on code size and algorithm of anti-virus software, and data size of virus pattern data. Thus, if the mail terminal has low processing power of the installed CPU, and a little amount of available memory, it is hard-pressed for the mail terminal to make virus inspection.

Although relatively small-sized and easily portable mail terminals such as cellular telephones and PDA are widely used particularly in recent years, these small-sized mail terminals, as compared with the desktop personal computer, are greatly limited in their CPU processing power and memory capacity from the standpoint of physical size and consumption power. Therefore, when virus inspection was executed within a small mail terminal with poor processing power, it would take a long time and consumes large power, and thus it would not be practical.

In addition, if the small mail terminal is connected to an external server in order to update the virus pattern, the user must pay for that operation and is thus disagreeable.

### SUMMARY OF THE INVENTION

In view of the above various problems, it is an object of the invention to provide an electronic mail system, mail server and mail terminal in which the external apparatus on the outside of the mail terminals previously decides if e-mails are each infected with virus so that the load on the mail terminals can be reduced and that the usability can be improved. It is another object of the invention to provide an electronic mail system, mail server and mail terminal that can make virus inspection that is suited to small-sized mail terminals having limited processing power. Further objects of the invention will be clear from the later description of embodiments.

In order to solve the above problems, an electronic mail system according to the invention is constructed to include a mail server and mail terminals that have the following features.

The mail server has virus decision means for deciding if the arrived e-mail is infected with virus, and information adding means for adding the viral infection decision result from the virus decision means to the e-mail. The mail terminal includes information offering means for offering the user the information of viral infection on the basis of the decision result added to the e-mail received from the mail server.

For example, the mail server installed at each domain can transmit and receive e-mails to and from a plurality of mail terminals. The virus decision means decides (inspect) if the e-mails arrived at the mail server are each infected with so-called computer virus. Here, the computer virus is a program that has the possibility of exerting such an adverse effect on other computer programs or data as to, for example, erase or rewrite contents stored in terminals or forward them to the outside.

The result of the decision of if the e-mail is infected with virus is added to the e-mail by the information adding means. Preferably, the decision result is added to the header of the e-mail. If the decision result is added within the header in which such e-mail's attributes as the sender, recipient, route and date are already written, the user can easily know if the e-mail is infected with virus or who sent the e-mail by only reading in the header.

As shown in the preferred embodiments of the invention, other information such as the name, type and feature of the virus with which the e-mail is infected or the countermeasure against the virus may be added to the e-mail as inspection information irrespective of presence or absence of viral infection. The e-mail with the decision result added is stored in the mailbox provided at each mail address and transmitted through the mailbox to the mail terminal.

When the mail terminal receives the e-mail from the mail server, the information offering means examines the decision result added within the e-mail, and offers information of the viral infection to the user. Here, for example, “warning that the e-mail is infected with virus” can be given as the information of viral infection. When the information added to the e-mail contains the type of virus or countermeasure against virus, the information offering means can offer the user these virus type and countermeasure in addition to the viral infection warning. The viral infection warning to the user is not limited to display of the warning message. If the mail terminal has other means for generating light, sound or mechanical vibration, the user can be warned by, for example, blinking a lamp, ringing a buzzer or vibrating the terminal's body itself.

Since the mail server decides if the e-mail is infected with virus and adds the decision result to the e-mail, the mail terminal is not required to inspect the viral infection, and the user of the mail terminal also does not need to make virus pattern updating operation.

The mail terminal may have operation restricting means for restricting the operation on the e-mail when the received e-mail is found infected with virus from the decision result.

The operation restricting means can limit, for example, displaying of the contents of the e-mail infected with virus.

Here, limiting displaying of the e-mail's contents means limiting reading of the e-mail in order to prevent the virus from exerting an adverse effect. Therefore, if the mail text is not infected with virus but only the attached file or files are infected with virus, only execution of the attached file or files is restricted, and the mail's text may be permitted to display. Thus, even when the mail terminal received the e-mail infected with virus, it could prevent the virus from setting in motion, suppressing damage.

The operation restricting means may restrict forwarding of the e-mail infected with virus to another terminal.

Here, “forwarding” also includes a so-called return mail. By limiting the forwarding of the e-mail infected with virus, it is possible to prevent another terminal from being infected with virus.

In addition, the operation restricting means permits the e-mail infected with virus to forward only to a predetermined apparatus, but not to other terminals.

Here, the predetermined apparatus may be, for example, an apparatus for inspecting virus (as an example, a personal computer in which a virus inspection program is already installed). Forwarding of e-mails to the predetermined apparatus can be made irrespective of whether the e-mails are infected with virus, so that the virus inspection can be made.

The “predetermined apparatus” can also be considered as “an apparatus directly connected to the mail terminal not through an external network”. By detecting the type of an interface for use in forwarding, it is possible to inhibit the forwarding through the external network (mail server) but permit the forwarding of e-mails only to a personal computer connected directly to the mail terminal.

According to another aspect of the invention, when the virus deciding means decides that the e-mail is infected with virus, the mail server can a delete a part of the e-mail to suppress the adverse effect of virus.

The mail server can delete the whole of the virus so that the action of the virus cannot cause an adverse effect or delete a part of the virus enough to make the virus powerless. A range to delete can be determined from safety assuring point of view.

In an electronic mail system according to another aspect of the invention, when the virus decision means decides that the e-mail is infected with virus, the mail server first transmits only the header of the e-mail to the mail terminal, and when the mail terminal requests the mail server to send, it transmits the whole of the e-mail to the mail terminal. When the user desires to receive the e-mail associated with the header first sent from the mail server, the mail terminal requests the mail server to send the e-mail.

When the e-mail is infected with virus, the mail server first transmits only the header of the e-mail to the mail terminal. When the user desires to receive the e-mail infected with virus, the mail server transmits the whole e-mail.

In an electronic mail system according to another aspect of the invention, the mail server further has bill management means for managing charges to e-mail services. When the virus deciding means decides that the e-mail is infected with virus, the bill management means stops the charging process to a recipient of the e-mail infected with the virus.

The bill management means can not only exempt the recipient of the e-mail infected with virus from the charge but also charge a sender who has sent the contaminated e-mail.

The present invention can be understood from the viewpoints of the mail server, mail terminal and computer program.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the whole construction of the electronic mail system of a first embodiment according to the invention.

FIG. 2 is a diagram schematically showing an electronic mail structure and a method of transmission.

FIG. 3 is a diagram showing the contents of a header and inspection information added as postscripts within the header.

FIG. 4 is a flowchart briefly showing all the processes in the mail server and mail terminal.

FIG. 5 is a diagram showing details on display of the mail terminal when it receives an e-mail infected with virus.

FIG. 6 is a flowchart of processes for displaying the e-mail.

FIG. 7 is a flowchart of processes for forwarding the e-mail.

FIG. 8 is a diagram schematically showing the main portions of the electronic mail system of a second embodiment according to the invention.

FIG. 9 is a flowchart of a mail forwarding process.

FIG. 10 is a flowchart of processes in the mail server according to a third embodiment of the invention.

FIG. 11 is a diagram schematically showing the whole construction of the electronic mail system according to a fourth embodiment of the invention.

FIG. 12 is a diagram schematically showing the whole construction of the electronic mail system according to a fifth embodiment of the invention.

FIG. 13 is a flowchart for a billing process.

FIG. 14 is a flowchart of the billing process in the electronic mail system according to a sixth embodiment of the invention.

FIG. 15 is a flowchart of processes on the mail server side in the electronic mail system according to a seventh embodiment of the invention.

FIG. 16 is a flowchart of processes on the mail terminal side.

### DESCRIPTION OF THE EMBODIMENTS

The electronic mail system, mail server and mail terminal according the embodiments of the invention will be described with reference to the accompanying drawings.

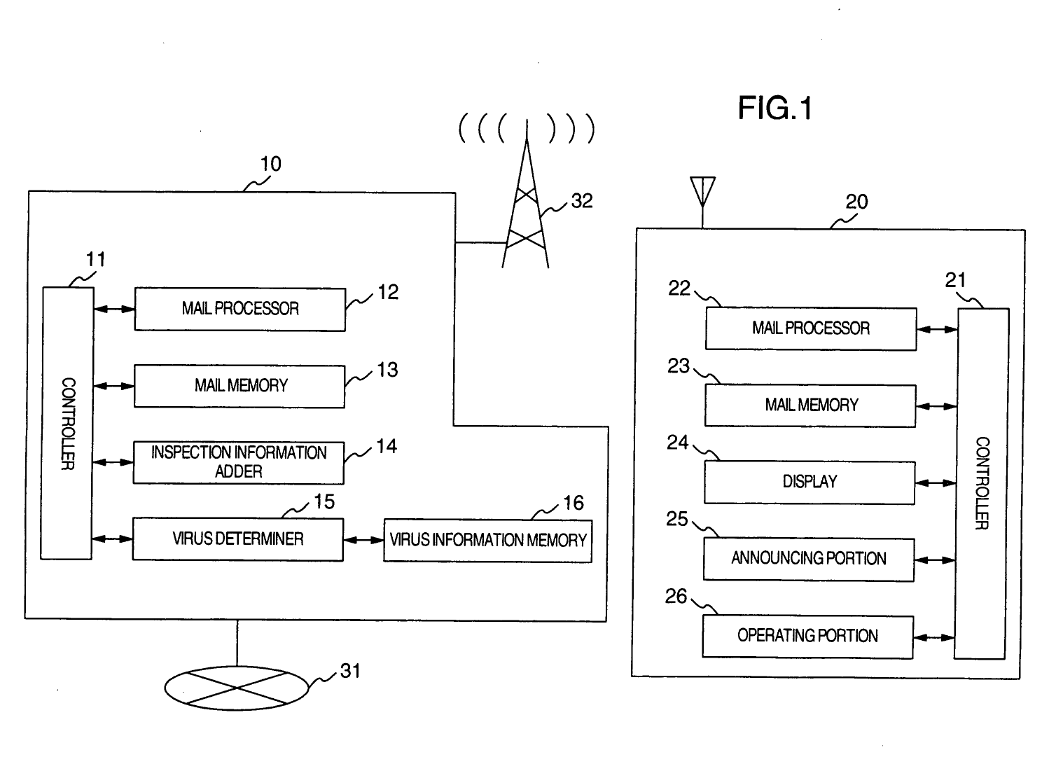

FIGS. 1 through 7 are concerned with the first embodiment of the invention. FIG. 1 is a diagram schematically showing the whole construction of the electronic mail system.

A mail server 10 that a mobile-phone carrier installs has, for example, a controller 11, a mail processor 12, a mail memory 13, an inspection information adder 14, a virus determiner 15 and a virus information memory 16.

The controller 11 controls the mail processor 12 and so on. The mail processor 12 makes processes for transmission and reception of e-mails between it and a mail terminal 20. The mail memory 13 stores arrived e-mails. The inspection information adder 14 adds inspection information, which will be described later, to the header of e-mail. The virus determiner 15 decides if the e-mail is infected with virus on the basis of the virus patterns previously stored in the virus information memory 16.

The mail server 10 is connected to the Internet 31. The e-mails transmitted from other terminals (not shown) through the Internet 31 arrive at the mail server 10. The e-mails arrived at the mail server 10 are subjected to a predetermined virus inspection, and then stored in the mail memory 13. The e-mails stored in the mail server 10 are transmitted to the mail terminal 20 from, for example, a cellular phone base station 32 by radio communication.

The mail terminal 20 is constructed as a small-sized terminal such as a cellular phone or PDA. In this embodiment, a cellular phone having the function to transmit and receive e-mails through the Internet is employed as the mail terminal 20.

The mail terminal 20 has a controller 21, a mail processor 22, a mail memory 23, a display 24, an announcing portion 25 and an operating portion 26.

The controller 21 controls the mail processor 22 and so on. The mail processor 22 makes processes for transmission and reception of e-mails according to the input operation on the operating portion 26. The mail memory 23 stores the e-mails received from the mail server 10. A non-volatile or static memory, for example, is employed as the memory. The display 24 is constructed as, for example, a liquid crystal display or plasma display to indicate the contents of e-mail and the status (for example, received signal strength and remaining power of battery) of the mail terminal.

The announcing portion 25 informs the user of arrival of e-mails by, for example, light, sound or vibration. Arrival of e-mails can also be informed of by two or more kinds of stimulants such as light and sound, sound and vibration, or light and vibration. In addition, the annunciation contents may be made different according to a case where an e-mail not infected with virus arrived (normal time) and a case where an e-mail infected with virus arrived (abnormal time). For example, the sound that is emitted when an e-mail of the abnormal time has arrived can be turned up or changed in its tone as compared with that when an e-mail of the normal time has arrived. Alternatively, the frequency or strength of the vibration may be changed according to the abnormal time or normal time of e-mail arrival.

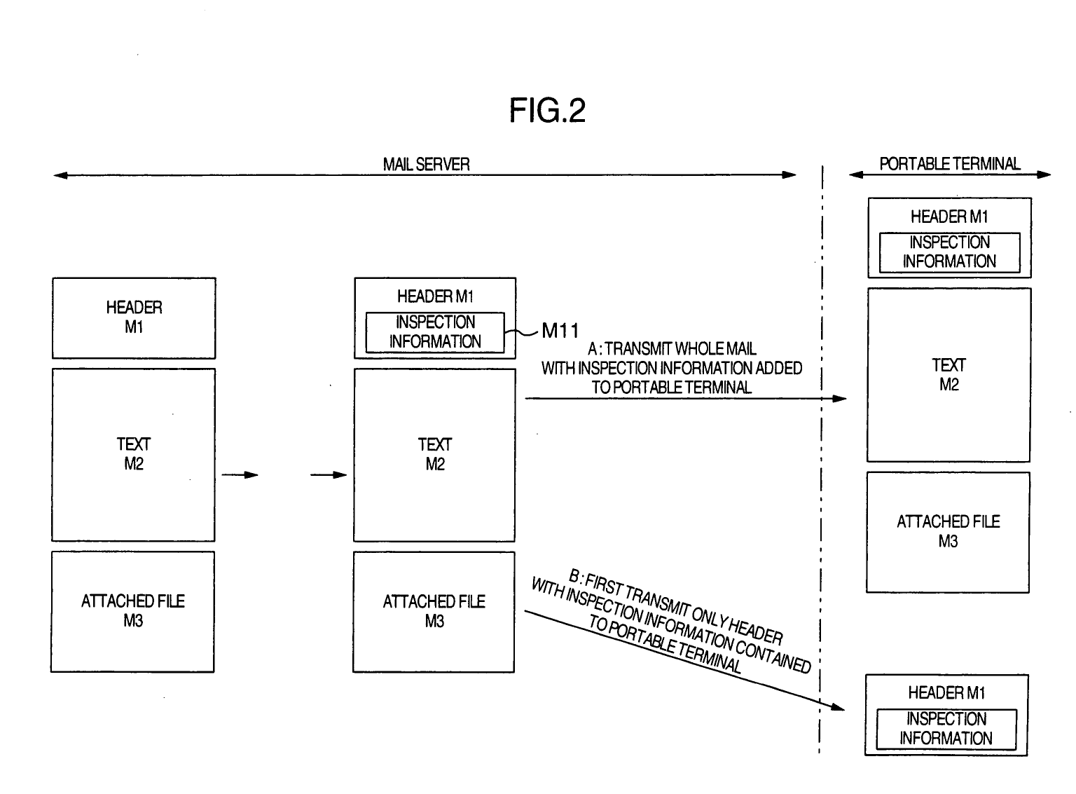

FIG. 2 is a diagram schematically showing the format of e-mail and how to add inspection information. The e-mail is roughly divided into a header M1, a text M2 and an attached file or files M3. Inspection information M11 that includes the results of the decision made by the virus determiner 15 of the mail server 10 is added within the header M1. The e-mail with the inspection information added is distributed to the mail terminal 20 in two different ways. In one way, the whole of the e-mail is transmitted to the mail terminal 20 (as indicated by “A” in FIG. 2), and in the other way, only the header M1 of e-mail is first transmitted to the mail terminal 20, and after the instruction from the user is received the whole of the e-mail is transmitted to the terminal (as indicated by “B” in FIG. 2). In this embodiment, the whole of the e-mail is first transmitted. In the other embodiment that will be described later, only the header M1 is first transmitted.

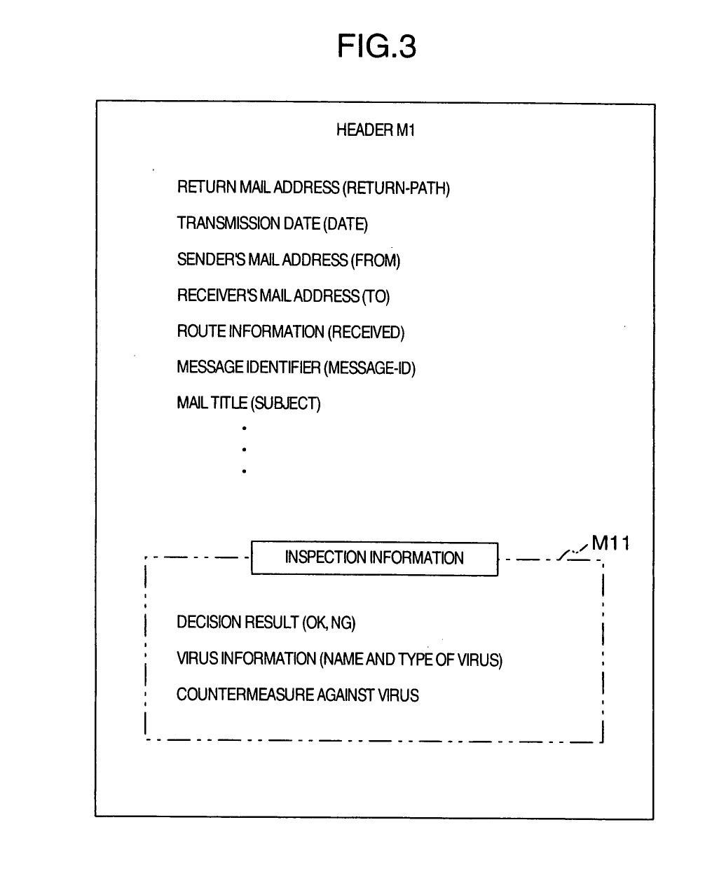

FIG. 3 is a diagram showing the format of the header. The header has details of bibliographic information such as return mail address (Return-Path), transmission date (Date), sender's mail address (From), receiver's mail address (To), route information (Received), message identifier (Message-ID), and mail title (Subject). In this embodiment, inspection information M11 is added within this header M1. The inspection information M11 may include, for example, decision result of presence or absence of viral infection, virus information (name and type of virus), and countermeasures against virus. Therefore, the mail terminal 20 can easily detect the inspection information M11 by examining the header M1 alone.

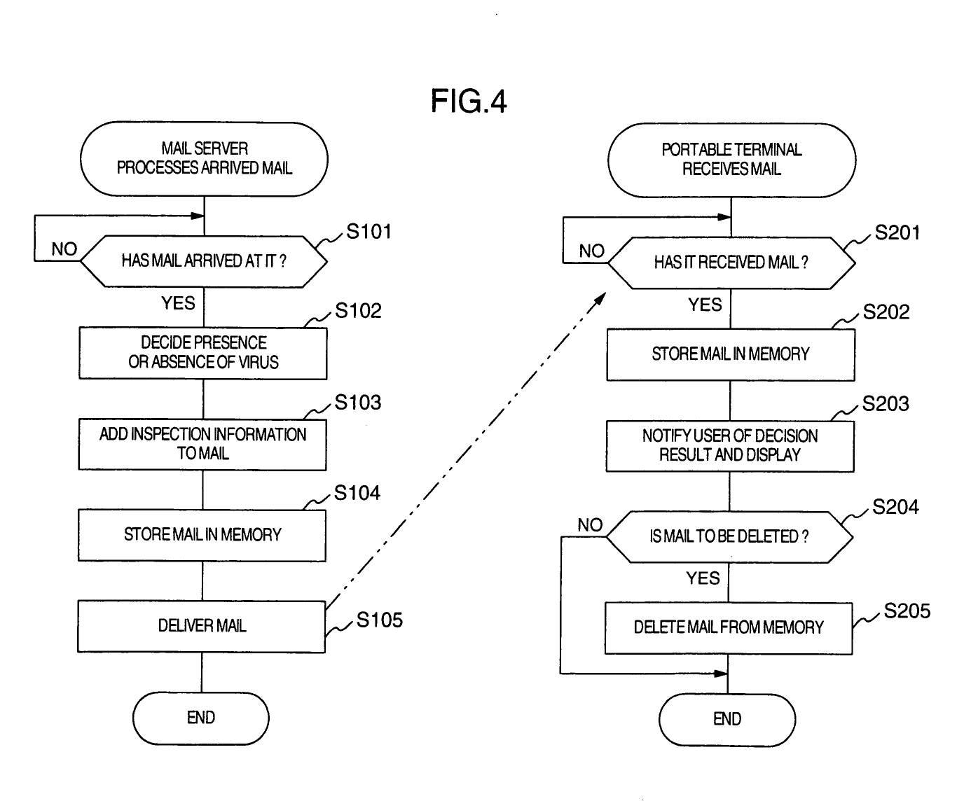

Action of this embodiment will be described with reference to FIGS. 4 through 7. In these figures, a step is abbreviated “S”.

FIG. 4 is a flowchart briefly showing all the processes to be performed in the mail server 10 and mail terminal 20.

When receiving the e-mail through the Internet 31 (S101: YES), the mail server 10 decides whether it is infected with virus or not (S102). When the decision of if it is infected with virus is finished, the inspection information M11 described above is written within the header M1 (S103). The e-mail with the inspection information M11 added is stored in the mail memory 13 at a directory according to the mail address (S104), and distributed to the mail terminal 20 (S105). In this case, after a request from the mail terminal has been sent, or without waiting for the request the e-mail can be distributed from the mail server 10 to the mail terminal 20.

When receiving the e-mail from the mail server 10 (S201: YES), the mail terminal 20 makes the received e-mail be stored in the mail memory 23 (S202). Then, the mail terminal 20 detects the inspection information M11 from the header M1, notifies the user of presence or absence of viral infection through the announcing portion 25, and makes the contents of the inspection information M11 be indicated on the display 24 (S203). Ways the terminal 20 informs the user of presence or absence of viral infection can be considered variously as given below. For example, either the annunciation sound tone is changed according to the virus decision result, or the blinking interval, blinking pattern or lighting color of the annunciation lamp is changed according to the virus decision result. If the annunciation device is a vibrator, the vibration interval or vibration pattern may be changed in accordance with the virus decision result.

When the received e-mail is infected with virus, the user can actuate the operating portion 26 to delete this e-mail (S204). When the user makes the deleting operation, the corresponding e-mail is deleted from the mail memory 23 (S205). Other processes to be made on the mail terminal 20 will be further described later.

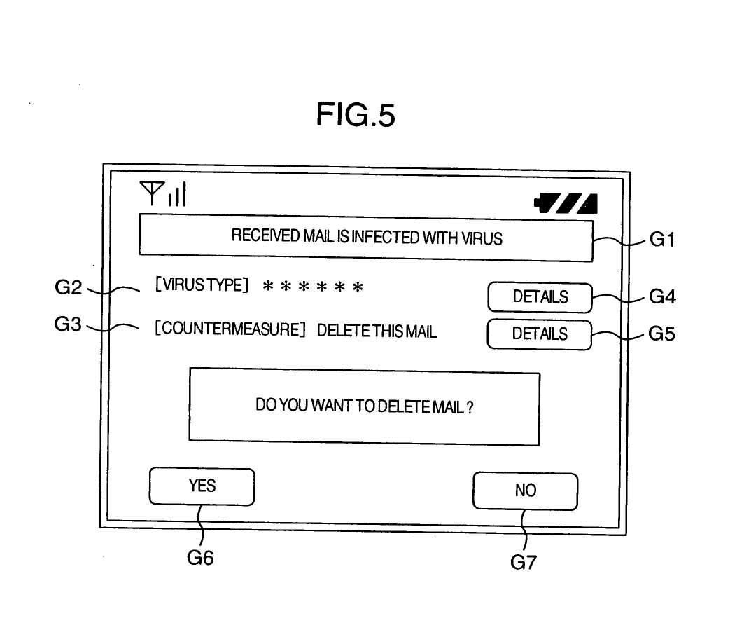

FIG. 5 is a diagram of a window image that shows the contents of inspection information M11 indicated on the display 24 for the user. As illustrated, a message of, for example, warning against the fact that the received e-mail is infected with virus can be displayed (G1). In addition, the type (G2) of virus and countermeasure (G3) against it can be displayed together with the warning message. Moreover, when the mail terminal 20 is like a small-sized cellular phone, the display area of the display 24 is small because of the limited physical size, and thus all the information may be difficult to indicate at a time. In that case, detailed contents may be indicated in a hierarchical fashion (G4, G5). Alternatively, window images on the screen may be scrolled to give detailed information.

Here, “delete” can be given as a countermeasure. The “delete” means that all the e-mail infected with virus is deleted from the mail memory 23. For example, “all delete” or “partial delete (delete only the attached file or files)” may be used as more segmentized options offered for the user.

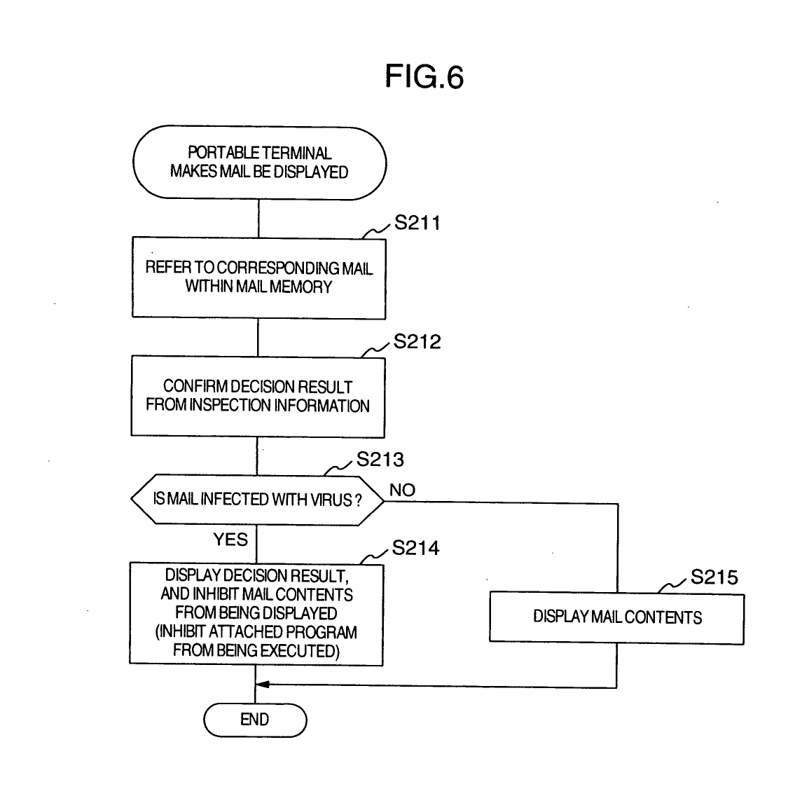

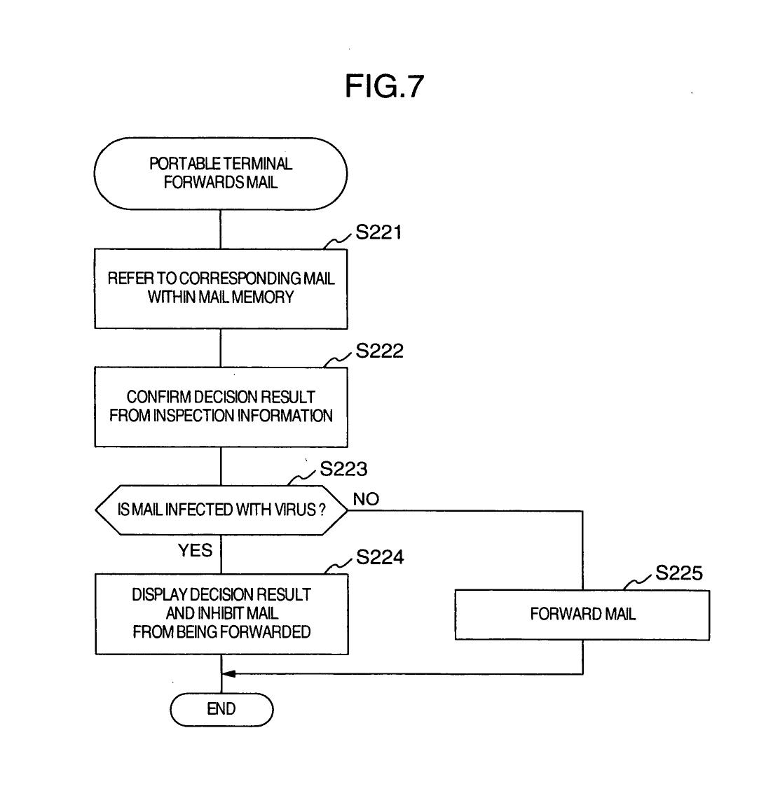

If the type of the virus that contaminates the e-mail is so old that the computer program of the mail terminal 20 can already cope with that virus, the e-mail infected with that virus will not be adversely affected by action of the virus. Therefore, in this case, the e-mail can be stored without “deleting”. Even if there is a possibility of an adverse effect of virus action on the e-mail, the e-mail can be stored without being deleted as long as the user desires to do so. In this case, the e-mail is stored within the mail memory 23 as is the normal e-mail. However, as described later with reference to FIGS. 6 and 7, the indication (execution of attached program) and forwarding of the e-mail infected with virus are restricted so that the safety can be assured.

FIG. 6 is a flowchart of processes for displaying the e-mails stored within the mail terminal 20.

When a user who desires access to the e-mails makes a predetermined display-actuation operation on the operating portion 26, browsing process is started. The mail processor 22 refers to the corresponding one of the e-mails stored within the mail memory 23 (S211), detects the inspection information M11 added to this e-mail, and confirms the result of decision of if the e-mail is infected with virus (S212).

If the e-mail is decided to have infection with virus (S213: YES), the decision result is displayed in a form of warning message, and the contents of the mail are inhibited from being displayed (S214). In other words, only the decision result is indicated on the display 24. Here, the contents to be inhibited include the program attached to the e-mail. The mail terminal controls this attached program with suspected virus action not to be executed. If the mail terminal finds the mail text safe with only the attached file or files contaminated with virus, it can control only the attached program file not to be executed, but permit the user to read the mail text.

When the e-mail is found not contaminated with virus (S213: NO), all the contents of the e-mail are displayed, and the attached program file, if present, is also executed (S215).

FIG. 7 is a flowchart of processes for forwarding e-mails stored in the mail terminal 20. Here, “forwarding” also means the case of “sending a reply” to a mail sender.

When a user who desires to forward e-mails stored within the mail memory 23 of the mail terminal 20 makes a certain forwarding operation through the operating portion 26, this forwarding processing is started. The mail processor 22 refers to the corresponding one of the e-mails stored within the mail memory 23 in accordance with the input operation on the operating portion 26 (S221).

Then, the mail processor detects the inspection information M11 from the referred e-mail, and confirms the result of decision of if the e-mail is infected with virus on the basis of this inspection information M11 (S222). If the e-mail to be forwarded is infected with virus (S223: YES), the decision result is displayed, and the mail is inhibited from being forwarded (S224). A message of, for example, “This mail is infected with virus *** and thus cannot be forwarded” can be displayed on the display 24. If the e-mail is the normal mail not infected with virus (S223: NO), the e-mail is forwarded to the address specified by the user (S225).

The effect of the above-mentioned embodiment will be described below.

Since the mail server 10 but not the mail terminal 20 actually makes the decision of viral infection, the mail terminal 20 can escape from loads of virus decision. Therefore, this fact benefits particularly the small-sized mail terminal such as a cellular phone or PDA that is constrained to reduce its CPU processing power and on-board memory capacity.

Moreover, since the mail server 10 makes the viral infection decision in a unitary manner, the mail server 10 alone can update the virus patterns and virus detection program, or the mail terminal 20 does not need to do so, thus making it possible to effectively perform the viral infection decision maintenance.

Since the mail server 10 previously makes the viral infection decision, and writes the decision result as the inspection information in the header of e-mail, the mail terminal 20 with no virus decision function can inform the user of presence or absence of viral infection.

If a countermeasure against virus is also included in the inspection information, the user can be urged to properly cope with virus and a user who is unaccustomed to handling the computer can be given feeling of security.

Moreover, if the contaminated e-mail is inhibited from being displayed or forwarded, the action of virus can be prevented from an adverse effect on the terminal and from second inflection to other terminals.

In addition, since the inspection information is written in the header of e-mail, the mail terminal 20 that received the e-mail can fast and easily detect the fundamental mail attributes such as the mail sender and route information and the attributes of viral infection decision.

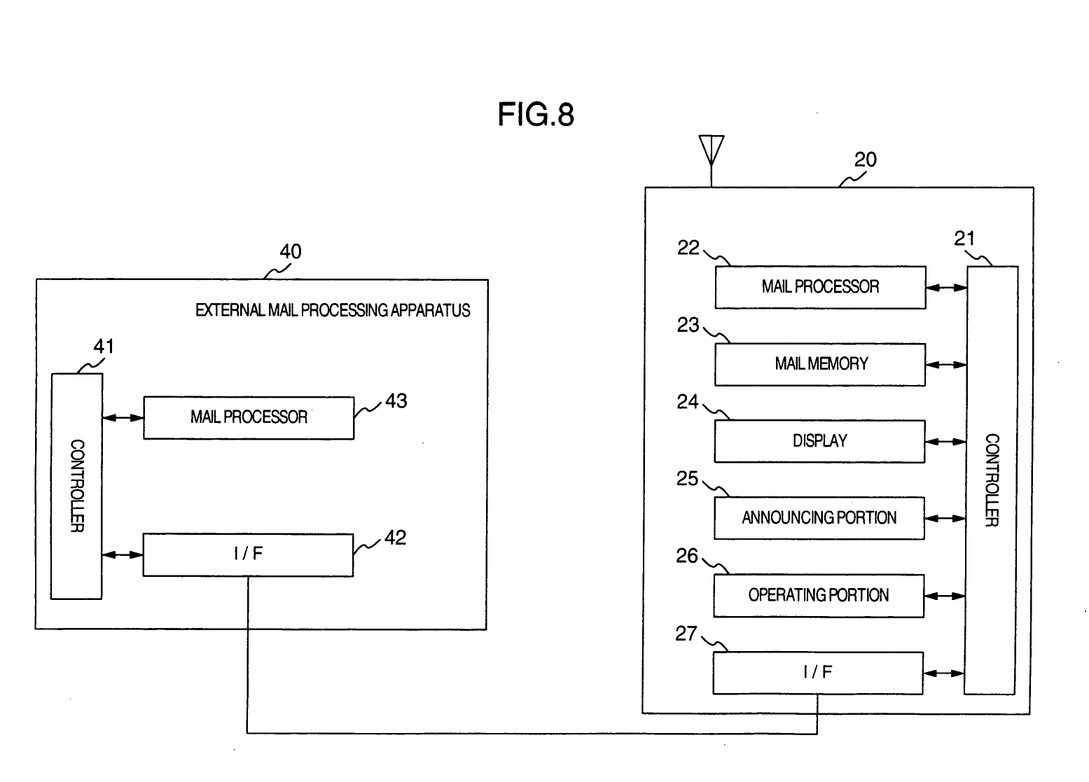

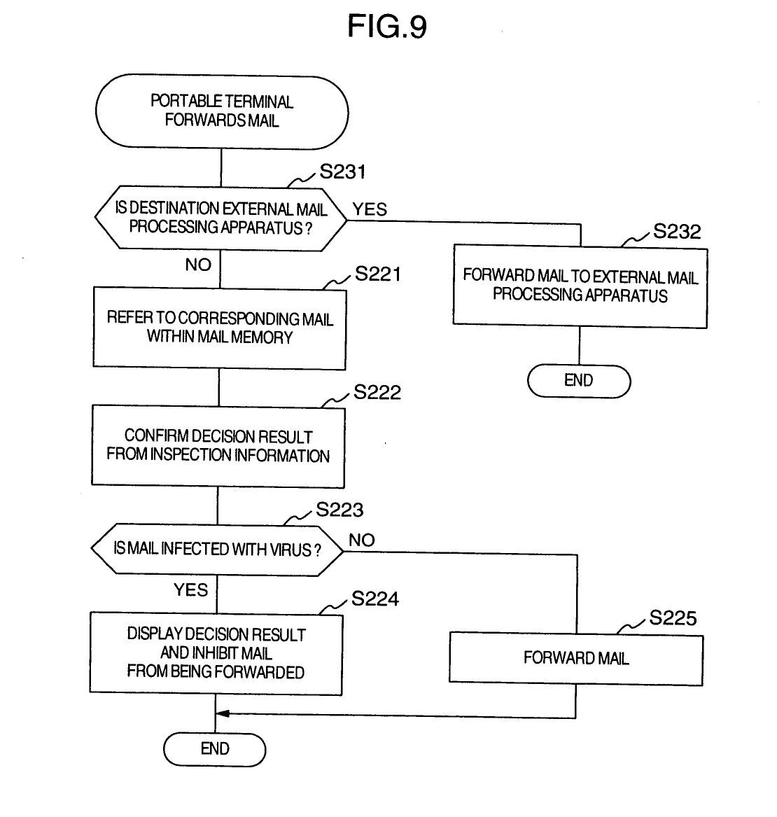

The second embodiment of the invention will be described with reference to FIGS. 8 and 9. In the following description, same or like elements corresponding to those in the previous description are identified by the same reference numerals and will not be described. The feature of this embodiment is that an external apparatus for examining the e-mails infected with virus is provided and allows the e-mails to be forwarded irrespective of presence or absence of viral infection.

An external mail-processing apparatus 40 is provided as, for example, an element of a personal computer with a virus inspection program provided or an external apparatus for exclusive use. This external apparatus has a controller 41, an interface (hereafter, referred to as “I/F”) 42, and a mail processor 43.

The external mail-processing apparatus 40 is connected by wire or radio through the I/F 42 to an I/F 27 of the mail terminal 20. The mail processor 43 examines the e-mail that is received through the I/F 27, 42. The controller 41 controls the mail processor 43 and I/F 42 to operate.

FIG. 9 is a flowchart of forwarding processes associated with this embodiment. These processes have new steps S231 and S232 in addition to the forwarding processes mentioned with reference to FIG. 6.

When the user makes a predetermined operation to forward e-mails, decision is made of if a forwarding destination specified by the user is the external mail-processing apparatus 40 (S231). If the forwarding destination is the external mail-processing apparatus 40, the e-mail is forwarded to the external mail-processing apparatus 40 without being examined about presence or absence of viral infection (S232).

Here, if the address specified as the forwarding destination is a mail address of another mail terminal expressed by user name+domain name such as “***@***.com”, the e-mail can be determined not to be forwarded to the external mail-processing apparatus, or can be inhibited from being forwarded. Alternatively, by detecting the type of I/F for use in forwarding of e-mail, it is possible to decide if the forwarding destination is the external mail-processing apparatus 40. In addition, if a forwarding program is called out from a mail-examining operation menu program transmitted from the external mail-processing apparatus 40 to the mail terminal 20, it can be decided to be the forwarding to the external mail-processing apparatus.

In the detailed examination of e-mails infected with virus, secondary infection may occur when a replay is sent through the mail server 10. In this embodiment, however, when the forwarding destination of e-mail is the external mail-processing apparatus 40 directly connected to the mail terminal 20, the forwarding can be allowed irrespective of the virus decision result. Thus, the secondary infection can be prevented from expanding and the virus inspection can be made.

That is, a so-called local-connection terminal (external mail-processing apparatus 40) allows forwarding of e-mails without condition, and the forwarding of e-mail to the terminal connected through the external network (Internet 31) is allowed depending on the result of viral infection decision. However, even if the local-connection terminal connected to the mail terminal 20 does not have a virus-processing program such as a mail-examining program, it is desirable to construct not to permit the forwarding from the safety point of view. In this case, for example, before the mail terminal 20 transmits e-mail to the external mail-processing apparatus 40, the mail terminal 20 requests whether the external mail-processing apparatus 40 has a virus processing function (or the external mail-processing apparatus can be given a function to voluntarily declare presence or absence of the virus processing function without waiting for a request from the mail terminal 20), or in step S231, decision is made of if “the forwarding destination is the external apparatus having the virus processing function”.

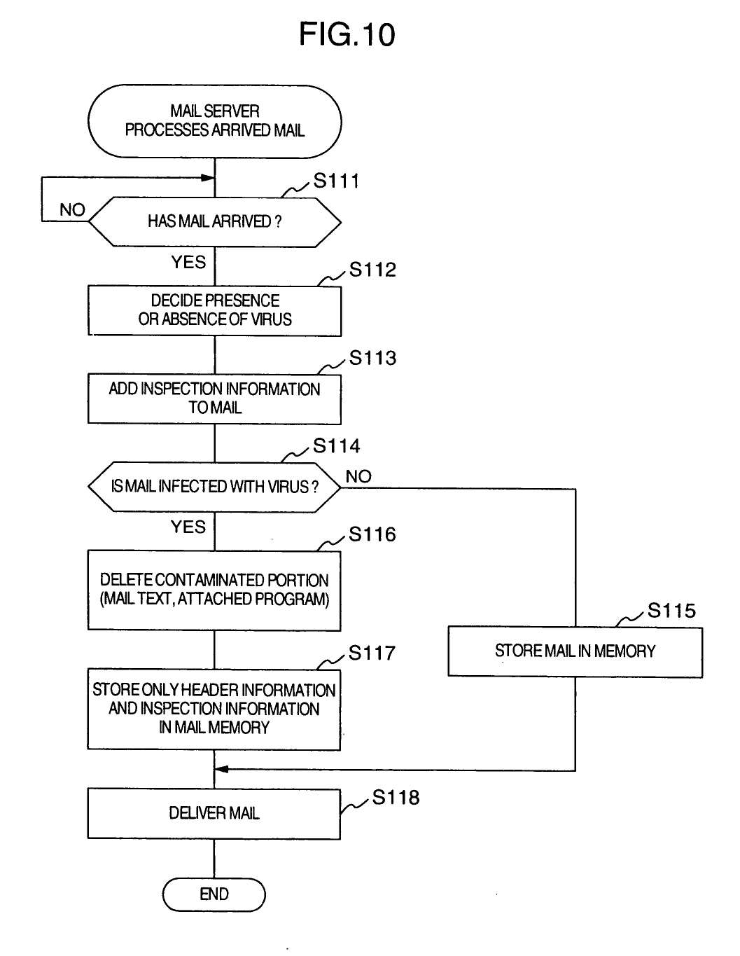

FIG. 10 is a flowchart of mail-server side processes associated with the third embodiment of the invention. The feature of this embodiment is that the e-mails infected with virus are each partially deleted and delivered to the mail terminal 20.

When the e-mail arrives at the mail server 10 (Sill), decision is made of if there is viral infection (S112), and the inspection information M11 is added to the header of e-mail (S113). If the e-mail is not infected with virus (S114: NO), the e-mail is directly fed to and stored in the mail memory 13 (S115) as it is. If the e-mail is infected with virus (S114: YES), the infected portion (or a portion that is deeply suspected of being infected with virus) is deleted from the e-mail (S116), and only the header's information and the inspection information (or together with other harmless portions) are stored in the mail memory 13 (S117). Thus, the stored e-mail is delivered to the mail terminal 20 (S118).

Here, the e-mail infected with virus can be stored after all the portions except the header and inspection information are uniformly deleted (method 1) or after only the attached program file that is likely to have been infected with virus is uniformly deleted (method 2) or after only the contaminated portion is deleted from the e-mail (method 3).

In the cases of methods 1 and 2, since only the previously selected portions are uniformly and automatically deleted from the whole e-mail, the processing can be simply made, and thus a large number of e-mails can be fast processed. In the case of method 3, since a differently contaminated portion is deleted from each of the e-mails, the processing becomes too complicated to be used for the process of a large number of e-mails. However, since the harmless portions can be more offered to the user, convenience can be improved. Thus, any one of the methods can be employed. Selection of any one of the methods can be determined depending on user's preference or the characteristics of e-mails. As an example of the processing that depends on the characteristics of e-mails, a large number of e-mails sent at a time from the same mail address is processed by use of method 1 or 2, and the mails sent in the other different way are processed by use of method 3.

According to this embodiment, since a part of the contents of the e-mail that the mail server 10 has decided to be infected with virus is deleted, the contaminated e-mail, even if the mail terminal 20 receives it, little exerts an adverse effect on the mail terminal when the virus is set in motion, and thus safety can be increased.

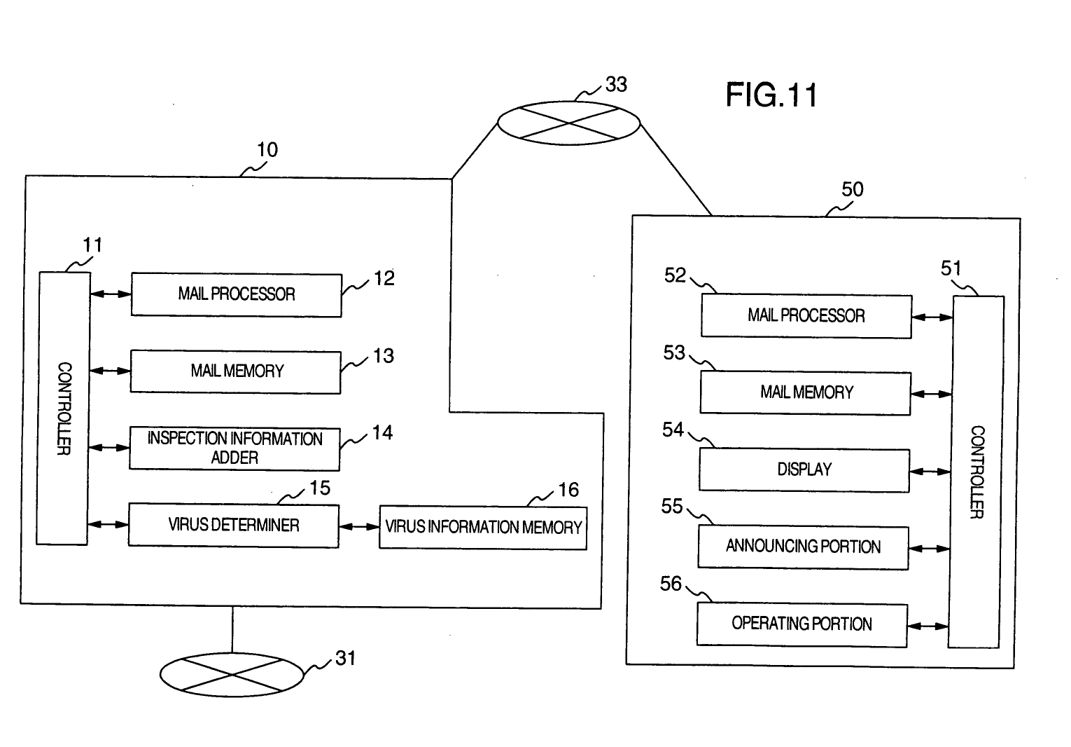

FIG. 11 is a diagram showing the whole construction of an electronic mail system according to the fourth embodiment of the invention. The feature of this embodiment is that the Internet 33 is used instead of the radio base station 32 shown in FIG. 1 in order to connect the mail server 10 and a mail terminal 50.

The mail terminal 50 can be constructed to have a controller 51, a mail processor 52, a mail memory 53, a display 54, an announcing portion 55 and an operating portion 56 as does the mail terminal 20 mentioned in the section of the first embodiment.

This mail terminal 50 may be, for example, a facsimile terminal equipment, a fixed telephone set, or any one of electrical goods (such as refrigerator, washer, electronic oven, audio goods, car navigation system and GPS).

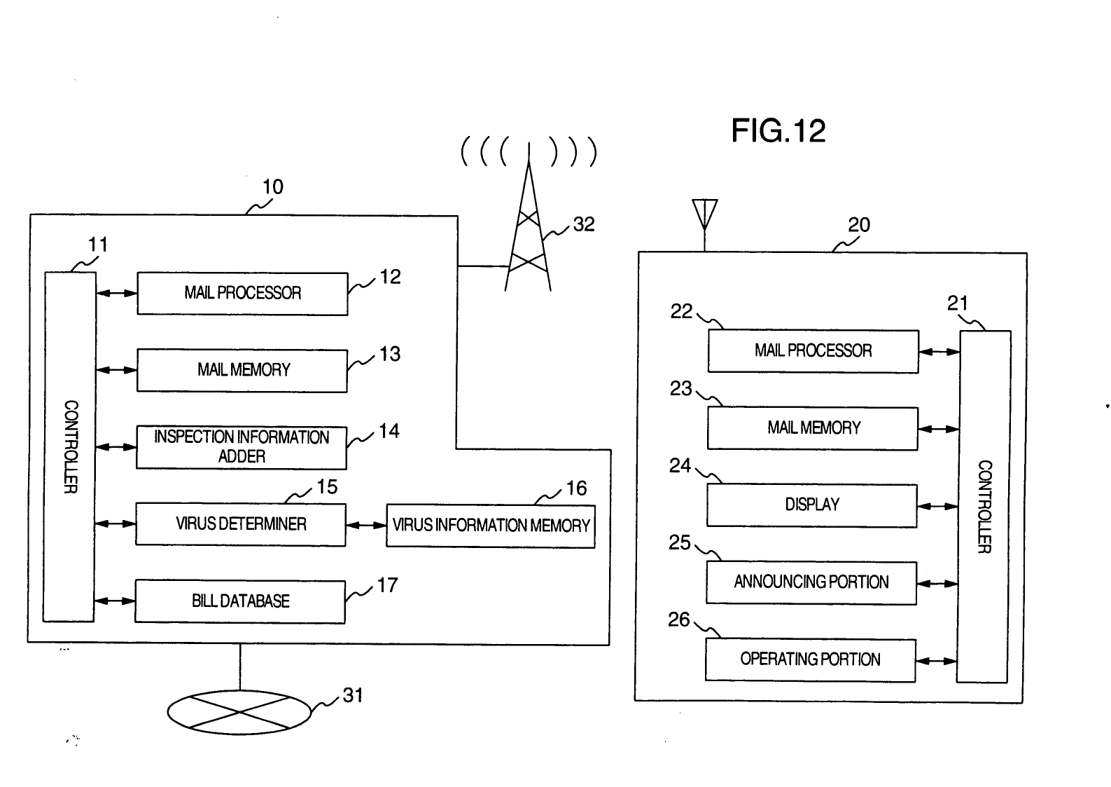

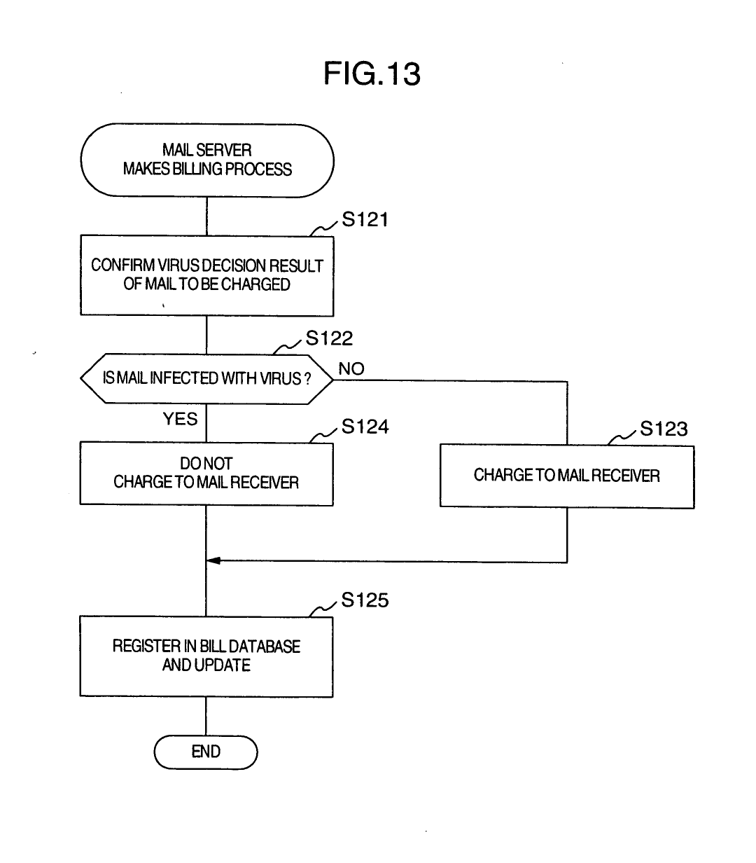

The fifth embodiment of the invention will be described with reference to FIGS. 12 and 13. The feature of this embodiment is that a user who received e-mails infected with virus is not charged for that communication.

In other words, the mail server 10 has a bill database 17 provided for managing charges to users of mail terminals 20 in order to charge for communication on the basis of the contents of this bill database 17.

FIG. 13 is a flowchart of processes for the billing operation of mail server 10. The result of decision of whether an e-mail to be charged to is infected with virus is confirmed (S121). If the e-mail to be charged to is found not infected with virus (S122: NO), a certain fee is charged to the addressee of the e-mail (S123). If the e-mail is found infected with virus (S122: YES), the billing process to the mail receiver is stopped (S124). Then, the billing database 17 is updated and the billing process ends (S125).

Thus, a user to whom the e-mail infected with virus is sent can be prevented from being charged, so that the user is satisfied with that process.

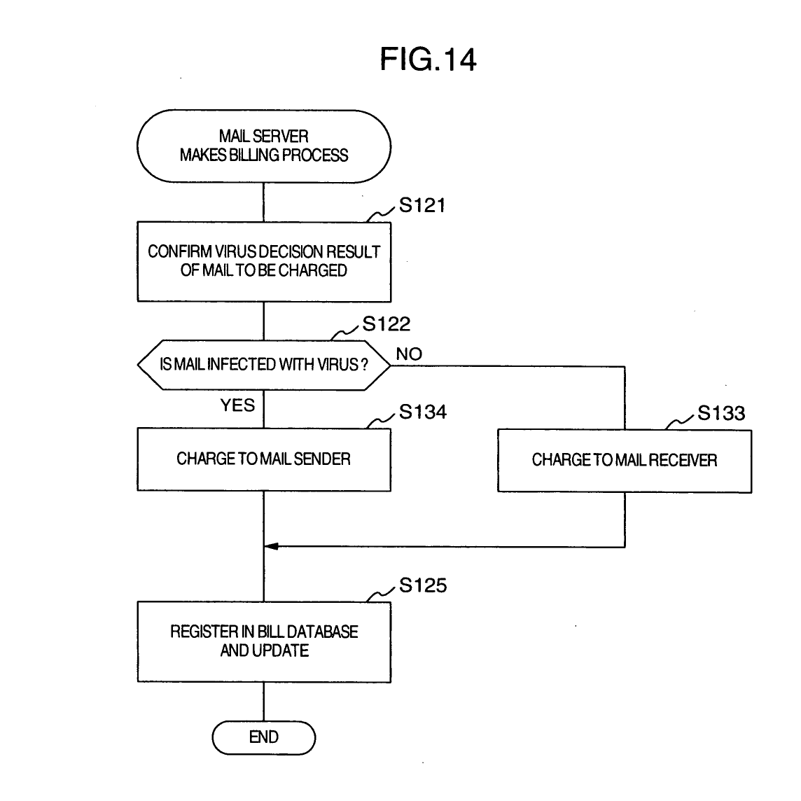

FIG. 14 is a flowchart for mail server's billing process associated with the sixth embodiment of the invention. The feature of this embodiment is that a normal fee is charged to a user who received a normal e-mail not infected with virus (S133), but no fee is charged to a user who received an e-mail infected with virus, in which case a sender who sent the contaminated mail is charged (S134).

In other words, when the sender sends the contaminated mail by cellular phone, referring to the billing database 17 of mail server 10 can identify the sender, and thus a penalty of having sent the contaminated mail can be imposed on the sender. In addition, a warning for alerting the mail sender that the sender has transmitted the contaminated mail may be automatically sent back. This warning e-mail can also be used in the fifth embodiment.

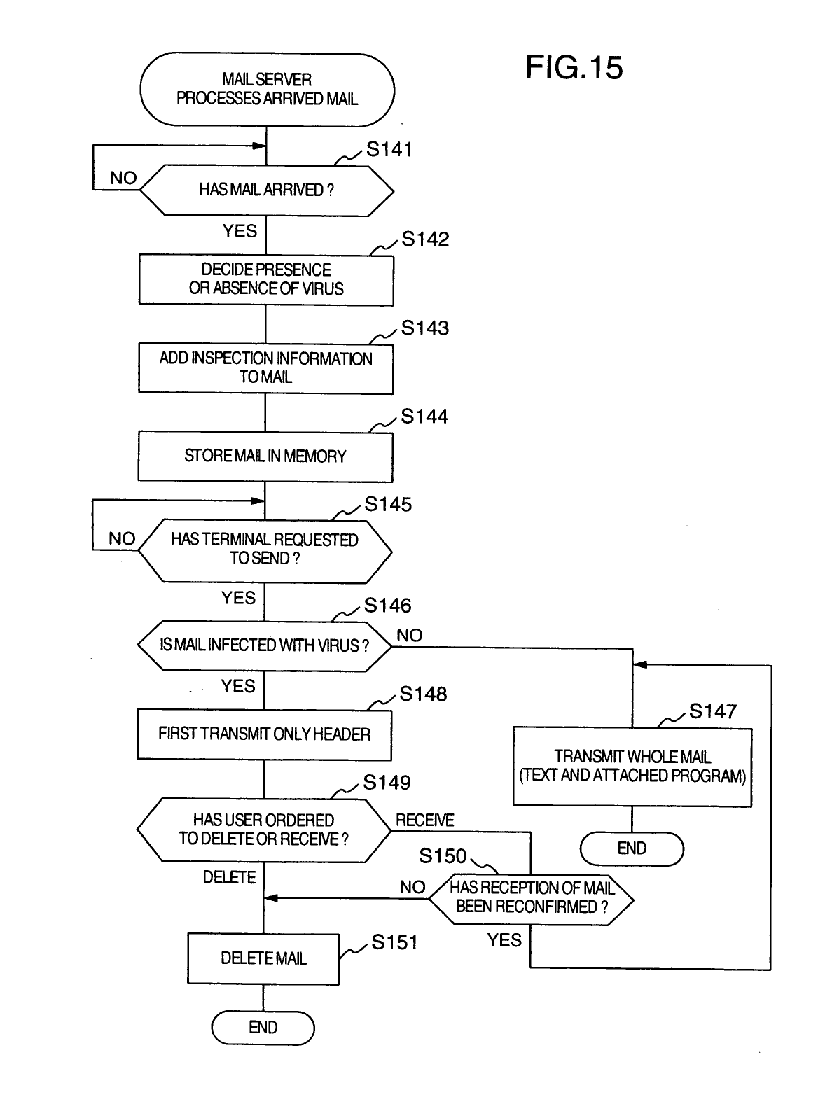

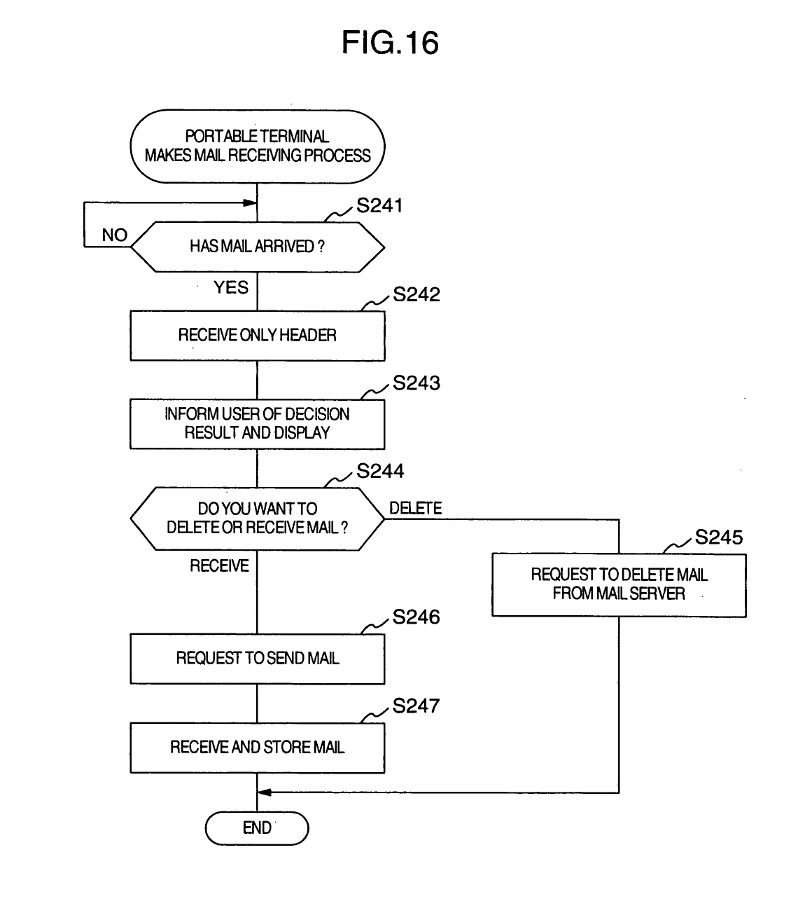

The seventh embodiment of the invention will be described with reference to FIGS. 15 and 16. The feature of this embodiment is that, as described with reference to FIG. 2, the mail server 10 first sends only the head containing the inspection information M11 to the mail terminal 20, and the whole e-mail is not transmitted until the user issues instructions to the mail server 10.

FIG. 15 is a flowchart for processes on the mail server. When an e-mail arrives (S141: YES), virus decision is made (S142), the inspection information M11 is added within the header of the e-mail (S143), and then the e-mail is stored in the mail memory 13 (S144). When the mail terminal 20 requests to send the e-mail (S145: YES), the mail server makes decision if the e-mail to this terminal 20 is infected with virus (S146).

If the e-mail is not infected with virus (S146: NO), the whole e-mail is immediately transmitted to the mail terminal 20 (S147). When the e-mail is infected with virus (S146: YES), only the header (that contains the inspection information M11) of the e-mail is first transmitted to the mail terminal 20 (S148).

The mail server waits for instructions from the user (S149). If the user wants to receive the e-mail infected with virus, the mail server again confirms through the mail terminal 20 that the user desires to receive (S150). If it is reaffirmed that the user is willing to receive (S150: YES), the mail server transmits the contaminated e-mail to the mail terminal 20 (S147). When the user cancels the reception of the e-mail (S150: NO), and when the user desires to delete the e-mail, the e-mail is deleted from the mail memory 13 (S151).

FIG. 16 is a flowchart for processing on the mail terminal. When the terminal detects that the e-mail has arrived (S241: YES), the mail server 10 first transmits only the header of the e-mail (S242), so that the user can be informed of the result of the viral infection decision based on the inspection information M11 contained in the header and see it on the display (S243). Thus, the user can get an option to receive or delete the e-mail on the basis of the displayed contents of the inspection information (S244). When the user selects to delete the e-mail, the mail terminal requests the mail server 10 to delete the corresponding e-mail (S245). When the user selects to receive the e-mail, the mail terminal 20 requests the mail server 10 to send the e-mail (S246). Thus, the whole e-mail freshly sent from the mail server 10 is stored in the mail memory 23 (S247).

Even this embodiment constructed as above can have the same effect as does the first embodiment. In addition, this embodiment does not send the whole e-mail infected with virus immediately, but it transmits first only the header containing the inspection information and does not transmits the whole e-mail until the user issues definite instructions. Therefore, safety can be further promoted.

The present invention is not limited to the above embodiments, but can be variously modified and changed by adding new constituent elements to the constructions mentioned above or removing some elements from the constructions as will be understood by those skilful in the art without departing from the spirit of the invention and the scope of the appended claims.

According to the invention, as described above, the electronic mail system can decide if respective e-mails are infected with virus without causing a burden of process on the mail terminals, thus assuring safety.

1-18. (canceled)

19. An electronic mail system having a mail server for managing e-mails, and mail terminals for transmitting and receiving the e-mails through the mail server, comprising:
a mail server including:
a virus detector which detects if an arrived e-mail is infected with virus; and
an information adder which adds a detection result from the virus detector to the e-mail,
a bill manager which manages charges to e-mail services, wherein the bill manager stops a billing process to a recipient of the e-mail infected with virus and commences a billing process to a sender of the infected e-mail when the virus detector detects that the e-mail is infected with virus,
each mail terminal including:
a controller which restricts operation on the received e-mail on the basis of the detection result when the received e-mail is infected with virus.

20. The electronic mail system according to the claim 19, each mail terminal further comprising:
an information offerer which offers information of viral infection to a user on a basis of the detection result added to the e-mail received from the mail server.

21. The electronic mail system according to claim 19, wherein the controller restricts displaying contents of the infected e-mail.

22. The electronic mail system according to claim 19, wherein the controller restricts forwarding the infected e-mail to another terminal.

23. The electronic mail system according to claim 19, wherein the controller allows the infected e-mail to be forwarded only to a predetermined apparatus but restricts forwarding of the infected e-mail to another terminal.

24. The electronic mail system according to claim 19, each mail terminal further comprising:
an inquirer which inquires of an outer device whether the outer device has a virus processing function,
wherein the controller allows infected e-mail to be forwarded to the outer device only if the outer device has a virus processing function.

25. The electronic mail system according to claim 19, wherein the information adder adds the detection result to a header of the e-mail.

26. The electronic mail system according to claim 19,
wherein the mail server first transmits only the header of the e-mail when the virus detector detects that the e-mail is infected with the virus, and transmits a whole of the e-mail to the mail terminal when the mail terminal requests to send the e-mail, and the mail terminal requests the mail server to send the e-mail when a user desires to receive the e-mail associated with the header first sent from the mail server.

27. The electric mail system according to claim 19, wherein the mail terminal is a mobile phone.

28. A mail server comprising:
a mail processor which manages e-mails;
a memory which stores the e-mails received through the mail processor;
a virus detector which detects if each of the received e-mails is infected with computer virus; and
a bill manager which manages charges to e-mail services, wherein the bill manager stops a billing process to a recipient of the e-mail infected with virus and commences a billing process to the sender of the infected e-mail when the virus detector detects that the e-mail is infected with virus.

29. The mail server according to the claim 28, further comprising:
an information adder which adds a detection result from the virus detector to the e-mails.

30. The mail server according to the claim 28,
wherein the mail server first transmits only the header of the e-mail when the virus detector detects that the e-mail is infected with the virus, and transmits a whole of the e-mail when the mail server receives a request.

31. A mail terminal, comprising:
a receiver which receives e-mails, including a detection result for each of the e-mails that is infected with a computer virus, from a mail server;
an information offerer which offers information of viral infection to a user on a basis of the detection result added to a received e-mail;
an inquirer which inquires of an outer device whether the outer device has a virus processing function; and
a controller which restricts operation on the received e-mail on the basis of the detection result added to the received e-mail when the received e-mail is infected with virus,
wherein the controller allows an infected e-mail to be forwarded to the outer device only if the outer device has a virus processing function.

32. A method of managing e-mails by a mail server, comprising:
detecting if an arrived e-mail is infected with virus;
adding a detection result from the virus detector to the e-mail;
stopping a billing process to a recipient of the e-mail infected with virus when the virus detector detects that the e-mail is infected with virus; and
commencing a billing process to a sender of the e-mail infected with the virus when the virus detector detects that the e-mail is infected with virus.
